(19) United States
(12) Patent Application Publication
(10) Pub. No.: US 2014/0293513 A1
(43) Pub. Date: Oct. 2, 2014

(54) GRAPHENE-BASED HIGH VOLTAGE ELECTRODES AND MATERIALS

(71) Applicant: Custom Electronics, Inc., Oneonta, NY (US)

(72) Inventors: Thor E. Eilertsen, Oneonta, NY (US); Yang Gao, Oneonta, NY (US)

(73) Assignee: Custom Electronics, Inc., Oneonta, NY (US)

(21) Appl. No.: 14/224,022

(22) Filed: Mar. 24, 2014

Related U.S. Application Data
(60) Provisional application No. 61/805,170, filed on Mar. 26, 2013.
(60) Provisional application No. 61/836,891, filed on Jun. 19, 2013.
(60) Provisional application No. 61/898,104, filed on Oct. 31, 2013.

(51) Int. Cl. H01G 9/042; H01G 9/00

(52) U.S. Cl. CPC H01G 9/042; H01G 9/0032
USPC 361/528; 428/367; 264/10; 427/122; 216/6

(57) ABSTRACT

The disclosure describes an improved electrode with high voltage standoff characteristics and improved graphene-based materials and methods of making them for use therein. A graphene-based thin film material is described that may be applied or transferred to a current collector to create the improved electrode. The thin film comprises high aspect ratio graphene platelets applied to the surface of a current collector or other substrate in a known ratio to a film binder material. The film is produced with a desired layer thickness and graphene-to-binder ratio to produce a desired voltage standoff for the electrode. The film may include additional materials to achieve the desired dielectric and mechanical characteristics for the application, such as ferroelectric ceramic nanorods with a high aspect ratio and high dielectric constant and/or graphene sheets. The thin film dielectric materials may have applications in more than just the anode of the graphene electrolytic capacitor, but find application as a dielectric layer in other electrical applications, such as batteries, electrode sensor arrays, and nano-scale solid-state electronics.

### RELATED APPLICATIONS

This application claims priority from U.S. Provisional Patent Application No. 61/805,170 filed Mar. 26, 2013 and titled “Graphene High Voltage Anode”, U.S. Provisional Patent Application No. 61/836,891 filed Jun. 19, 2013 and titled “Electrospinning Ceramic Graphene Hollow Nanorods for High Voltage Anodes”, and U.S. Provisional Patent Application No. 61/898,104 filed Oct. 31, 2013 and titled “Tuning the Graphene Electrolytic Capacitor with BTO”.

### FIELD

The invention relates to the field of electrochemical energy storage and conditioning devices and, more specifically, dielectric electrodes and graphene-based materials for use therein.

### BACKGROUND

A novel type of electrolytic capacitor based upon graphene nanomaterials has been proposed in U.S. application Ser. No. 13/659,508, “Graphene Electrolytic Capacitor”. The graphene electrolytic capacitor is an improved electrolytic capacitor with a graphene dielectric layer. The graphene dielectric layers may be used in a variety of electrolytic capacitor configurations, including as part of a cathode electrode with a layered graphene energy storage layer and an anode with a strongly dielectric graphene dielectric layer.

One of the challenges of the graphene electrolytic capacitor is formulation and configuration of the strongly dielectric graphene dielectric layer for the anode. More specifically, there is a desire to tune the dielectric performance of the graphene dielectric layer to meet the voltage standoff specifications for the device.

Development of effective materials and physical structures to produce an electrode that combines the desired dielectric and mechanical properties in a manufacturable form is needed. While nanostructures that can be grown directly on the desired surface have been considered, thin films that can be applied to a current collector substrate or that are produced on a separate substrate and transferred to the current collector are under consideration, putting the focus on thin film components, formulation, and specific layered structures.

A variety of materials have been used for dielectrics, electrodes, electrolytes, and other components of both electrolytic capacitors and electric double layer capacitors (ELDCs). While the two types of devices may have some similar structural and electrical characteristics, the performance characteristics and electrochemical nature of ELDCs mean that there are different design parameters and similar materials may not be functionally equivalent in ELDCs versus electrolytic capacitors.

Graphene is a carbon structure that is a one-atom-thick planar sheet of sp2-bonded carbon atoms. They form a two-dimensional hexagonal crystal lattice (though it has been observed to have a tendency to roll or buckle). Graphene is the basic building block of other graphitic structures, being rolled into nanorods, balled into fullerenes, and stacked into graphite. A graphene platelet is a small stack of graphene sheets that are generally 1-100 nanometers thick and up to 100 micrometers in diameter. Stable graphene platelets are typically at least 3 atomic layers thick and thousands of atoms across, leading to aspect ratios (length to thickness) of greater than 500:1. The difference between graphite (graphene platelets are a naturally occurring component of graphite) and graphene platelet structures is a consistent coplanar orientation among the graphene platelets.

Graphene is presently being explored for use in a variety of electrical components, including ELDCs and nano-scale integrated circuit components. In ELDCs, graphene is primarily under consideration as coated electrodes or current collectors or in a variety of graphitic nanostructures to provide a nanoporous alternative to activated carbon. A nano-scale electrostatic capacitor comprised of graphene sheet electrodes and a graphene derived thin film as the insulating layer has also been proposed.

100% graphene solutions appear unlikely (from both a mechanical stability and manufacturability perspective) for most electrode uses. Instead, graphene may be mixed with other materials in a thin film binder to produce composite graphene films with the desired dielectric and other characteristics. The resulting thin film dielectric materials may have applications in more than just the anode of the graphene electrolytic capacitor, but find application as a dielectric layer in other electrical applications, such as batteries, electrode sensor arrays, and nano-scale solid-state electronics.

### SUMMARY

### Technical Problem

Novel materials and structures are needed to meet the voltage standoff requirements for the graphene dielectric layers in graphene electrolytic capacitors and other applications requiring a highly dielectric thin film layer. Thin film materials composed exclusively of graphene platelets grown on the current collector do not appear to have the desired characteristics and manufacturability for real-world applications, such as the graphene electrolytic capacitor.

### Solution to Problem

The present invention is an improved electrode with high voltage standoff characteristics and improved graphene-based materials and methods of making them for use therein. A graphene-based thin film material is described that may be applied or transferred to a current collector to create the improved electrode. The thin film comprises high aspect ratio graphene platelets applied to the surface of a current collector or other substrate in a known ratio to a film binder material. The film is produced with a desired layer thickness and graphene-to-binder ratio to produce a desired voltage standoff for the electrode. The film may include additional materials to achieve the desired dielectric and mechanical characteristics for the application, such as ferroelectric ceramic nanorods with a high aspect ratio and high dielectric constant.

In one embodiment, a novel material for use in a highly dielectric thin film is described. Ferroelectric ceramic nanorod shells define interior spaces and graphene cores are disposed within the interior spaces. The graphene-filled ceramic nanorods may be applied in a thin film with polymeric binder materials in a known ratio and thickness to achieve the desired voltage standoff.

In one embodiment, a method of making a novel material for use in a highly dielectric thin film is described. The method includes the steps of placing a ceramic formulation in a first pump connected to an outer needle, placing a graphene formulation in a second pump connected to an inner needle, and electrospinning nanofibers with a ceramic nanorod shell and a graphene core. The electrospun nanofibers may then be annealed and milled to the desired tetragonal ferroelectric structure and aspect ratio and applied in a thin film with polymeric binder materials in a known ratio and thickness to achieve the desired voltage standoff.

In one embodiment, a method of making a highly dielectric thin film is described. A first substrate, such as a copper or nickel target, with a target surface is placed in an environment for a chemical vapor deposition process. Chemical vapor deposition is used to grow a substantially uniform layer of graphene on the target surface of the first substrate to form a graphene sheet thin film dielectric. The graphene sheet thin film dielectric is transferred to a second substrate, such as an aluminum current collector for an electrode.

### Advantageous Effects of Invention

The present invention provides an improved highly dielectric graphene-based thin film for use in electrodes with high voltage standoff requirements, such as the anode of a graphene electrolytic capacitor. Advantages include tuning of the thin film dielectric to the voltage standoff requirements of the application and improved manufacturability compared to graphene-based dielectrics that are primarily graphene.

### BRIEF DESCRIPTION OF DRAWINGS

FIG. 1

Diagram of the layered structure of an electrolytic capacitor with an example highly dielectric electrode in accordance with an embodiment of the present invention.

FIG. 2

Diagram of a dielectric thin film applied to a current collector to form a highly dielectric electrode in accordance with an embodiment of the present invention.

FIG. 3

Diagram of multiple thin film layers applied to a current collector to form a highly dielectric electrode in accordance with an embodiment of the present invention.

FIG. 4

Diagram of ceramic nanorod material for use in a highly dielectric electrode in accordance with an embodiment of the present invention.

FIG. 5

Diagram of a dielectric thin film applied to a current collector to form a highly dielectric electrode in accordance with an embodiment of the present invention.

FIG. 6

Block diagram of a method of making a highly dielectric electrode in accordance with an embodiment of the present invention.

FIG. 7

Block diagram of a method of making a ceramic nanorod material for use in a highly dielectric electrode in accordance with an embodiment of the present invention.

FIG. 8

Block diagram of a method of making and transferring a graphene sheet thin film for use in a highly dielectric electrode in accordance with an embodiment of the present invention.

### DESCRIPTION OF EMBODIMENTS

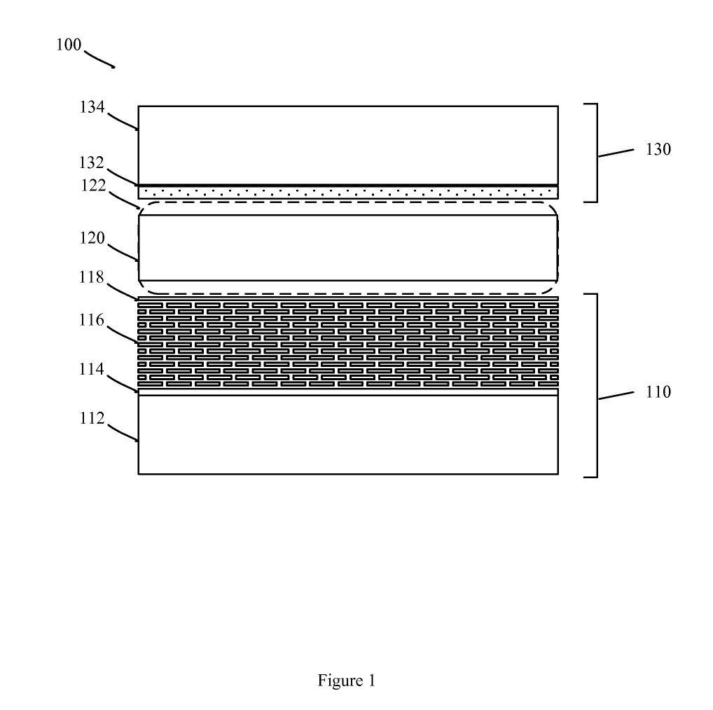

FIG. 1 shows the graphene electrolytic capacitor (GEC) 100 with a highly dielectric electrode of the present invention acting as the anode. GEC 100 is a double layer capacitor, or 2 capacitors in series, akin to its cousins the conventional electrolytic capacitor and ELDC. The GEC 100 has a capacitance that lies between the maximum capacitance of its conventional electrolytic counterpart (2500 μF) and less than most ELDCs; its voltage stand-off is less than the conventional electrolytic but much larger than the ELDC.

GEC 100 is a layered stack of functional subcomponents similar to other electrolytic capacitors and ELDCs. FIG. 1 is an idealized cross-section of the stack to show the component layers. In reality, these layers are formed in strips or coated on top of, rolled, pressed and placed in a cylindrical canister with appropriate leads for connecting the finished capacitor to an electric circuit in the desired application.

GEC 100 includes a first electrode 110. The first electrode 110 is a graphene-based cathode, unlike the electrodes of prior art electrolytic capacitors. More specifically, the graphene dielectric 118 is laminated or coated to the aluminum current collector (along with graphene energy layer 116 and graphene conductive paste 114). This is unlike the electrolytic capacitor's dielectric, aluminum oxide, which is formed when the current collector is electrochemically anodized in a bath of hot electrolyte. The first electrode 110 includes a current collector 112, a conductive coating 114, a graphene energy storage layer 116, and a graphene dielectric 118. Note that the designation of “first” and “second” in reference to electrodes or other structures is an arbitrary way of distinguishing between two or more structures of similar apparent function or composition. It is not to be assumed that “first electrode” is synonymous with cathode or “second electrode” is synonymous with anode, as these designations may vary based on the specific configuration and application of the capacitor or component electrode.

The graphene layers (conductive coating 114, energy storage layer 116, dielectric layer 118) of the first electrode 110 are created using thin film application of graphene platelets in desired configurations for the various functional layers.

Thin film graphene sheets are formulated for the desired parameters for each application of GEC 100. These high level parameters may include: (i) a high capacitive density, targeting up to 5 farads per cell and beyond; (ii) a large surface area, 2600 m²/g has been projected to yield over 150 F/cm³; and (iii) initial voltage withstanding window, up to 50 volts based upon the very high resistive value inherent when vertically stacking graphene platelets. Graphene platelet selection (thickness, diameter, rate of pin hole defects, etc.) and layer thickness may be controlled for desired parameters.

The first electrode 110 is adjacent separator 120 in GEC 100. The separator 120 electrically separates the first electrode 110 from the second electrode 130, defining the separate anode and cathode portions of the capacitor and preventing short circuits. The separator 120 is generally made from a cellulose medium that can be impregnated with the electrolyte 122, such as various separator papers that are well known in the art. In one embodiment, Kraft paper, an absorbent cellulose paper, is selected for desired electrochemical, chemical, mechanical, and electrical properties. Depending on the thinness of the selected paper, it may be used to assure adequate capacity for electrolyte storage and voltage breakdown. In alternate embodiments, various cellulose separator papers engineered for added durability and specific porosity, mechanical strength and high temperature resistance may be used as the separator 120.

The separator 120 is impregnated with an electrolyte 122. The electrolyte 122 is absorbed in the separator 120, but also able to engage the surface of the adjacent first electrode 110 and second electrode 130. In one embodiment, the electrolyte 122 is a non-aqueous electrolyte consisting of a weak acid, a salt of a weak acid and a solvent. The solvent is generally one of the polyhydroxyl alcohol group such as a glycerol or glycol although in some cases it may be replaced with the use of a hydroxy alkylamine. The salt of the weak acid is generally a salt of the weak acid employed although this is not necessarily always true. Non-aqueous electrolytes may also contain inert filler materials, for the purpose of increasing viscosity, such as bentonite, diatomaceous earth, silica gel, aluminum oxide, agar-agar, gum tragacanth and starch. In some instances, inert substances are added to the electrolyte for the purpose of increasing electrical conductivity. Such substances may be magnetite, graphite, colloidal graphite, carbon, colloidal silver or powdered metals such as aluminum and copper. Straight organic acids of the water soluble types or organic acids associated with a salt may be employed. For example, acetic acid or formic acid alone or in combination with such salts as ammonium acid borate, sodium borate, sodium potassium tartarate, ammonium phosphate, sodium acetate or ammonium acetate may be used. Illustrative of the aliphatic acids which may be employed are: Propionic acid, acrylic acid and butyric acid. Derivatives of the mono-carboxylic acids may also be employed, these being represented by such compounds as the following: lactic acid, hydroxy-acrylic acid, crotonic acid, ethylene lactic acid, dihydroxy propionic acid, isobutyric acid, diethyl acetic acid, iso-amyl acetic acid and iso-butyl acetic acid. Solid electrolytes may also be employed including poly(3,4-ethylenedioxythoiphene) or PEDOT combined with polystyrene sulfonate from solvents such as propanediol, methyl pyrrolidone, dimethylsulfoxide, or sorbitol and tetracyanoquinodimethane or TCNQ combined with tetrathiafulvene or TTF from such solvents.

The method of impregnation of the electrolyte 122 into the separator 120 may involve immersion of the elements and application of vacuum-pressure cycles with or without heat or, in the case of small units, just simple absorption.

GEC 100 also includes a second electrode 130 to act as the anode for the electrolytic capacitor. The anode electrode 130 includes the aluminum current collector 134 and a graphene dielectric thin film 132 which alongside the electrolyte dielectric balances the large voltage differential within the cell. Due to the asymmetric design of GEC 100, second electrode 130 is a much simpler structure. In the present embodiment, the second electrode 130 is a discrete current collector 134 of a composition similar to the current collector 112 in the first electrode 110. The current collector 134 of the second electrode 130 is made from capacitor-grade aluminum foil having at least 99.99% purity. Commercially available “Cathode Foil” that is chloride etched 10% is well suited to the application. The etched surface (not shown) of the current collector 134 of the second electrode 130 may also provide a binding surface for a graphene thin film dielectric layer. Foil thickness may be selected from the range 17 um to 35 um, with 25 um being a preferred thickness. In order to provide the high voltage capacity for the device, the majority of the voltage must be distributed across the anode. A much thicker graphene dielectric thin film 132 on the anode, compared to the cathode, will accomplish this.

Based on the dielectric constant of graphene from laboratory testing a 50 to 150 nm thickness would be required for a 50 volt withstand to be accomplished. This would be determined by the application and voltage specifications for the device, whether it be as a pulsed forming network or constant DC. The pulse forming network requires a higher di/dt therefore thicker dielectric.

In one embodiment, the graphene dielectric thin film 132 is formed onto the current collector 134 by applying a thin film coating with a binder matrix. The thin film comprises high aspect ratio graphene platelets applied to the binding surface of a current collector or other substrate in a known ratio to a film binder material. For example, the graphene platelets may represent a weight percentage of as little as 0.1% to as high as 10% of the total weight of the graphene dielectric thin film 132. The film is produced with a desired layer thickness and graphene-to-binder ratio to produce a desired voltage standoff for the electrode. The film may include additional materials to achieve the desired dielectric and mechanical characteristics for the application, such as ferroelectric ceramic nanorods with a high aspect ratio and high dielectric constant.

In an alternate embodiment, the graphene dielectric thin film 132 may be applied in multiple layers to achieve a desired thickness, where each layer has substantially the same composition. Alternatively, different layers may comprise different components, ratios, and thicknesses to achieve a net dielectric effect across all layers. Each film layer has a substantially uniform distribution of component materials. In one embodiment, one or more thin film layers may be graphene sheets formed on a separate substrate and transferred to the stack of graphene dielectric layers to form the graphene dielectric thin film 132.

Once the layered stack of the GEC 100 is formed, it is wound and packaged. The appropriate mandrel should be selected based on the package size and physical constraints of the layered structures. In one embodiment, a 3″ mandrel is used for winding.

There are a variety of packaging options and lead configurations. When packaging is selected, metallization, such as sputtering or evaporation, can be used to produce an electrically connected lead, through which all current is charged and discharged. The lead should be mechanically and electrically robust enough to withstand the voltage and current demands of the rapid changes the GEC 100 is designed for. Specifically, the lead should be rounded and relatively defect free, without burs or sharp edges.

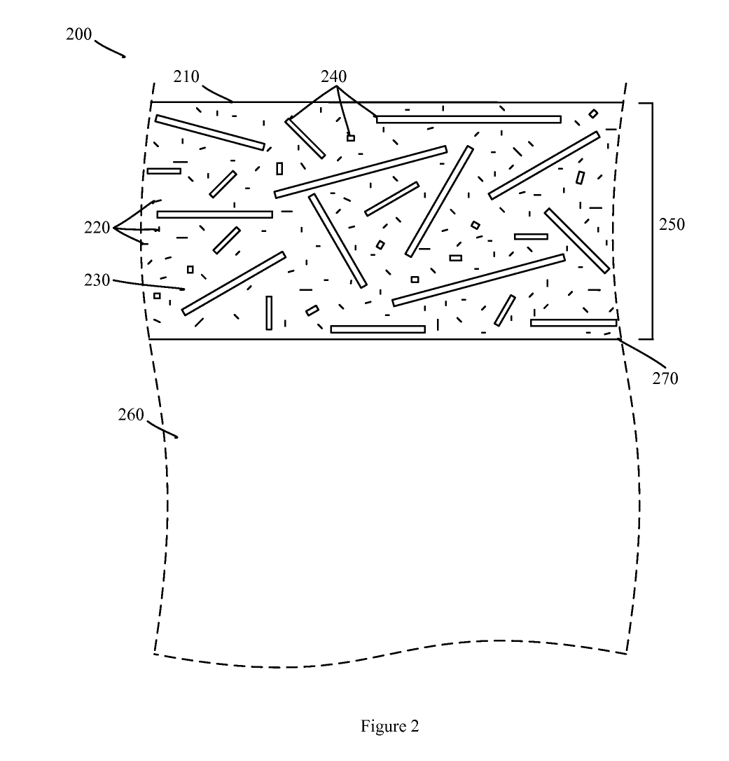

FIG. 2 shows a diagram of a dielectric thin film 210 applied to a current collector 260 to form a highly dielectric electrode 200 in accordance with an embodiment of the present invention. For example, highly dielectric electrode 200 could be used as the anode electrode 130 in GEC 100 in FIG. 1. FIG. 2 is a magnified cross-section of a small portion of electrode 200 which would extend laterally in both directions beyond the curved dotted lines flanking the figure due to the large difference between the width of the electrode 200 and the thickness of the dielectric thin film 210. It would also extend downward beyond the curved dotted line along the bottom of the figure due to the much greater thickness of the current collector 260 relative to the thickness of the dielectric thin film 210. Electrode 200 is designed to meet voltage standoff requirements in the range of 10-100 volts and the composition and thickness of dielectric thin film 210 is tuned to the specifications of a particular application or device, including high dielectric constant and relatively high capacitance.

Dielectric thin film 210 includes high aspect ratio graphene platelets 220 in a binder material 230 and ceramic material 240 with a high aspect ratio and high dielectric constant. The graphene platelets 220, binder material 230, and ceramic material 240 are in a predefined and desired ratio, and mixed and applied such that each component is substantially uniformly distributed through the dielectric thin film (in all directions). The graphene platelets 220, binder material 230, and ceramic material 240 are mixed with a solvent and then applied to the current collector 260 in a precisely controlled coating process to achieve a desired thickness 250. The solvent is removed by a curing process causing the binder material 230 to harden into a matrix supporting the distributed graphene platelets 220 and ceramic material 240. In one embodiment, the ratio of the graphene platelets 220 to the binder material 230 is in the range of 0.1-10.0 weight percent. The ratio of the ceramic material to the total dielectric thin film is in the range of 20-80 weight percent. The binder material 230 makes up the balance of the composition. The combined ratios would be in the following ranges: 0.1-10.0 wt % graphene platelets: 20-80 wt % ceramic material: 17-79 wt % binder material. An example composition of materials is: 2.5% graphene platelets, 78% ceramic material, 19.5% binder material. Once the desired composition of dielectric thin film 210 is determined, the desired thickness 250 for the required device and application specifications is determined. Desired thickness 250 is in the range of 1 um to 500 um.

In one embodiment, the graphene platelets 220 are a powder that is mixed with the other components before coating. The graphene platelets 220 are small stacks of graphene sheets that are generally 1-100 nanometers thick and up to 100 micrometers in diameter. Stable graphene platelets are typically at least 3 atomic layers thick and thousands of atoms across, leading to aspect ratios (length to thickness) of greater than 500:1. An exfoliated graphene powder with the desired high mean aspect ratio may be used as a graphene platelet source. Unlike some other graphene configurations for dielectric applications, the orientation of graphene platelets 220 relative to the current collector 260 is uncontrolled and may be randomly dispersed. The graphene platelets 220 can improve the dielectric and voltage standoff characteristics of dielectric thin film 210 and are effective at concentrations of 10% or less of dielectric thin film 210 when combined with another highly dielectric material with a high aspect ratio.

In one embodiment, the binder material 230 is a polymeric binder with known application in thin film application. For example, binder material 230 may be poly(vinyl pyrrolidone) (PVP), polyvinylodine fluoride (PVDF), copolymers of PVP, or copolymers of PVDF, such as PVDF-TFE (trifluoroethylene). For example, a 19.5% composition of PVDF may be used as binder material 230.

In one embodiment, the ceramic material 240 is a ferroelectric ceramic nanomaterial such as: BaTiO3 (barium titanate), Pb(Zr, Ti)O3 (lead zirconate titanate) also called PZT, CaCu3Ti4O12 (CCTO), Calcium barium zirconate titanate (Ba0.95Ca0.05Zr0.15Ti0.85O3, BCZT), etc. Any ceramic material that forms a stable nanostructure with a high aspect ratio (greater than 1,000 to 1) and high dielectric constant (greater than 100) may be appropriate for this application. Electrospun tetragonal nanorods are advantageous and can be milled into ceramic powders with the desired length and mean aspect ratio. The ceramic content should be tuned to the desired breakdown voltage. If the ceramic content is too low, the breakdown voltage becomes low and the electrode 200 will not have the desired voltage standoff. If the ceramic content is too high, the dielectric thin film 210 becomes too rigid and does not have acceptable mechanical strength.

In one embodiment, the current collector 260 is an aluminum current collector. Current collector 260 is made from capacitor-grade aluminum foil having at least 99.99% purity. Commercially available “Cathode Foil” that is chloride etched 10% is well suited to the application. The etched surface of the current collector 260 provides the binding surface 270 for a dielectric thin film 210. Foil thickness may be selected from the range 17 um to 35 um, with 25 um being a preferred thickness.

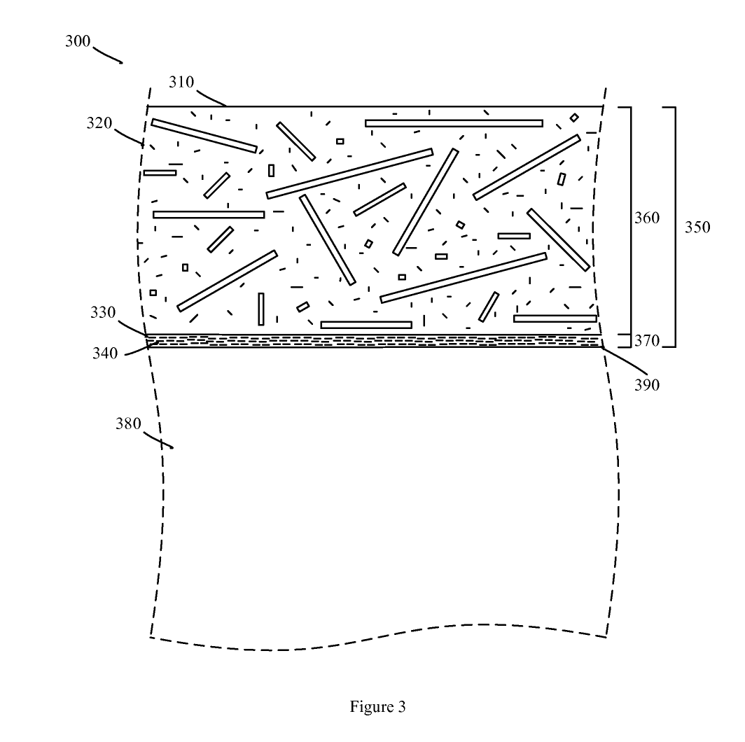

FIG. 3 shows a diagram of multiple thin film layers 320, 330 that make up a dielectric thin film 310 applied to a current collector 380 to form a highly dielectric electrode 300 in accordance with an embodiment of the present invention. For example, highly dielectric electrode 300 could be used as the anode electrode 130 in GEC 100 in FIG. 1. FIG. 3 is a magnified cross-section of a small portion of electrode 300 which would extend laterally in both directions beyond the curved dotted lines flanking the figure due to the large difference between the width of the electrode 300 and the thickness of the dielectric thin film 310. It would also extend downward beyond the curved dotted line along the bottom of the figure due to the much greater thickness of the current collector 380 relative to the thickness of the dielectric thin film 310. Electrode 300 is designed to meet voltage standoff requirements in the range of 10-100 volts and the composition and thickness of dielectric thin film 310 is tuned to the specifications of a particular application or device, including high dielectric constant and relatively high capacitance.

In one embodiment, electrode 300 is substantially similar to electrode 200 in FIG. 2, except that the dielectric thin film 310 in electrode 300 is made of multiple thin film layers 320, 330. Thin film layer 320 is a composite dielectric thin film made from graphene platelets, binder material, and ceramic material. See the description above for dielectric thin film 210 for further details of thin film layer 320. Rather than being coated directly on the current collector 380, thin film layer 320 is coated in top of thin film layer 330 to create a graphene thin film stack with the aggregate characteristics needed for electrode 300. Thin film layer 320 has a desired layer thickness 360 of 1-500 um.

In one embodiment, thin film layer 330 is comprised of graphene sheets 340 formed on a separate substrate and transferred to current collector 380. For example, thin film layer 330 may be composed of graphene sheets grown on a target substrate by chemical vapor deposition, then transferred to current collector 380. The graphene sheets 340 are grown to a desired layer thickness 370 during deposition or grown through multiple depositions and stacked to achieve the desired layer thickness 370. Graphene sheets 340 may be produced with a desired layer thickness from 0.1 nm to 100 nm. Due to the unique characteristics of graphene sheets, they may have a substantial impact on the dielectric and mechanical aspects of the dielectric thin film 310 even though their desired layer thickness 370 is orders of magnitude smaller than the desired layer thickness 360 of thin film layer 320 and may have limited impact on the overall desired thickness 350 of the dielectric thin film 310. For example, a dielectric thin film 310 could include a 1 um composite thin film layer 320 and a 1 um graphene sheet thin film layer 330.

The tuning of the voltage standoff, dielectric constant, capacitance, and mechanical characteristics using composition and film thickness will take into account the contributions of both thin film layers 320, 330, such that the net voltage standoff, dielectric constant, capacitance, and mechanical characteristics meet the specifications for electrode 300. While the embodiment shown in FIG. 3 includes two thin film layers with very different compositions, namely graphene/ceramic/binder composite and graphene sheets, it will be understood that any number of thin film layers could be used to achieve the desired aggregate characteristics, including multiple composite thin film layers with varying thicknesses and compositions. Similarly, the stack of thin film layers may be applied in a different order and does not necessarily require that the graphene sheets 340 be placed on the bonding surface 390 of the current collector 380.

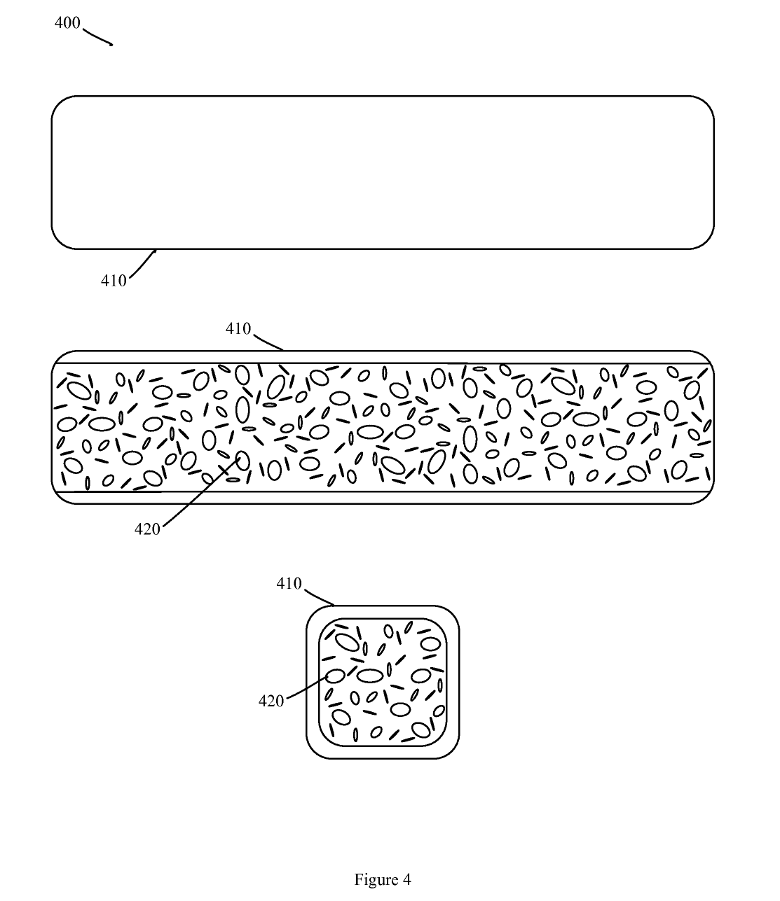

FIG. 4 shows a diagram of ceramic nanorod material 400 for use in a highly dielectric electrode in accordance with an embodiment of the present invention. The ceramic nanorod material 400 has a high dielectric constant, greater than 100, and high aspect ratio (length to width), greater than 1000:1. For illustrative purposes, the example fiber of ceramic nanorod material 400 is shown greatly shortened (with an aspect ratio of about 4). In one embodiment, the ceramic nanorod fibers are formed in very long strands and milled to the appropriate length for the desired mean aspect ratio in their powdered form.

The ceramic nanorod material 400 is made of a highly dielectric ceramic nanorod shell 410 and graphene core 420. In one embodiment, the ceramic nanorod shell 410 is made from a ferroelectric ceramic material, such as: BaTiO3 (barium titanate), Pb(Zr, Ti)O3 (lead zirconate titanate) also called PZT, CaCu3Ti4O12 (CCTO), Calcium barium zirconate titanate (Ba0.95Ca0.05Zr0.15Ti0.85O3, BCZT), etc. For example, tetragonal BaTiO3 forms a highly dielectric ceramic nanorod shell through an electrospinning process. To form stoichiometric BaTiO3, a synthesis of barium acetate and titanium isopropoxide is first grown in a Sol-Gel process. It will be understood that other materials, such as acetic acid and poly(vinyl pyrrolidone) PVP, will be used in the Sol-Gel process. The compounds from the Sol-Gel process are dissolved in acetic acid and mixed or stirred for a designated period of time to assure even dissolution and distribution of components. This precursor is mixed with a solution of PVP and inserted into a syringe for electrospinning of uniaxially aligned nanorods. The resulting BaTiO3 nanorod fibers are harvested, annealed to achieve the tetragonal structure, and milled to the desired aspect ratio.

In one embodiment, the graphene core 420 is comprised of graphene nanoplatelets disposed within the interior space of the ceramic nanorod shell 410. The graphene nanoplatelets have a mean aspect ratio (diameter to thickness) greater than 500:1 and are distributed substantially evenly throughout the interior space of the ceramic nanorod shell. The orientation of the graphene nanoplatelets may be uncontrolled and a fixed orientation is not required for most applications. For example, graphene nanoplatelets of the desired size and aspect ratio are acquired in their powdered form. The graphene nanoplatelet powder is mixed in a mineral oil formulation and inserted into a syringe for electrospinning within a ceramic shell. This is achieved through a core/shell dual needle electrospinning system with simultaneous feed of the ceramic precursor formulation and graphene/mineral oil formulation.

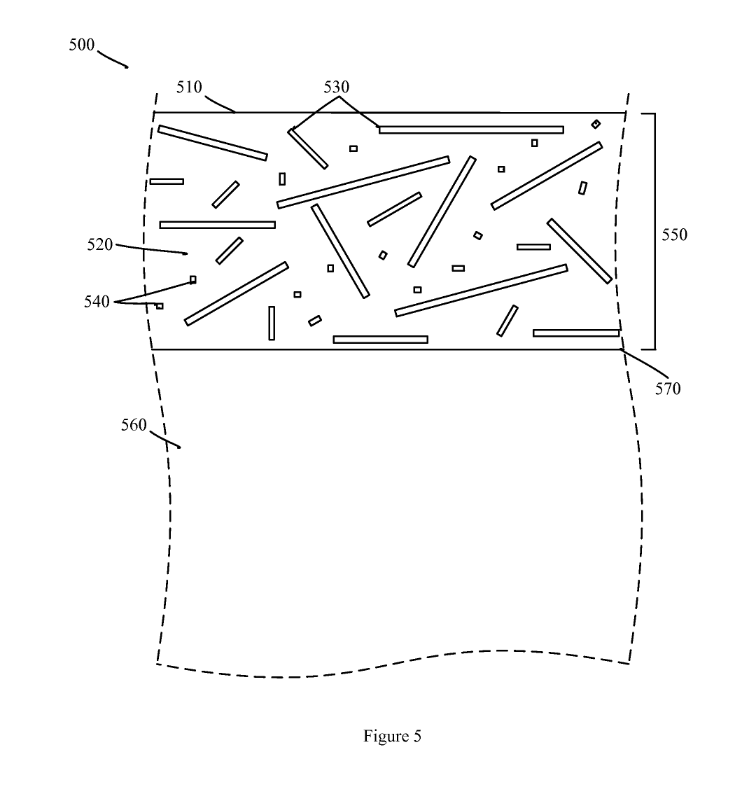

FIG. 5 shows a diagram of a dielectric thin film 510 applied to a current collector 560 to form a highly dielectric electrode 500 in accordance with an embodiment of the present invention and utilizing a ceramic nanorod material with a graphene core, such as the ceramic nanorod material 400 in FIG. 4. For example, highly dielectric electrode 500 could be used as the anode electrode 130 in GEC 100 in FIG. 1. FIG. 5 is a magnified cross-section of a small portion of electrode 500 which would extend laterally in both directions beyond the curved dotted lines flanking the figure due to the large difference between the width of the electrode 500 and the thickness of the dielectric thin film 510. It would also extend downward beyond the curved dotted line along the bottom of the figure due to the much greater thickness of the current collector 580 relative to the thickness of the dielectric thin film 510. Electrode 500 is designed to meet voltage standoff requirements in the range of 10-100 volts and the composition and thickness of dielectric thin film 510 is tuned to the specifications of a particular application or device, including high dielectric constant and relatively high capacitance.

In one embodiment, electrode 500 is substantially similar to electrode 200 in FIG. 2, except that the dielectric thin film 510 in electrode 500 utilizing a ceramic nanorod material with a graphene core, such as the ceramic nanorod material 400 in FIG. 4, instead of having separate graphene platelets and ceramic materials. The dielectric thin film 510 is a composite dielectric thin film made from a binder material 520 and ceramic nanorod material 530. The graphene cores 540 are visible only in ceramic nanorods oriented such that one of the distal ends is facing the viewer. Otherwise, it is hidden by the ceramic nanorod shell.

Dielectric thin film 510 includes high aspect ratio graphene nanoplatelets incorporated into graphene cores 540 within ceramic nanorod material 530, which has a high aspect ratio and high dielectric constant. The ceramic nanorod material 530 is distributed in the binder material 520. The graphene cores 540, binder material 520, and ceramic nanorod material 530 are in a predefined and desired ratio defined by the relationship between the graphene cores 540 and ceramic nanorod material 530. The binder material 520 and ceramic nanorod material 530 are mixed and applied such that ceramic nanorod material 530 (and thus the graphene cores 540) are substantially uniformly distributed through the dielectric thin film 510 (in all directions). The binder material 520 and ceramic nanorod material 530 are mixed with a solvent and then applied to the current collector 560 in a precisely controlled coating process to achieve a desired thickness 550. The solvent is removed by a curing process causing the binder material 520 to harden into a matrix supporting the distributed ceramic nanorod material 530. In an alternate embodiment, additional ceramic material or graphene platelets may be mixed with the binder material 520 and ceramic nanorod material 530 to supplement the ratios of graphene or ceramic components. In one embodiment, the ratio of the graphene cores 540 to the binder material 520 is in the range of 0.1-10.0 weight percent. The ratio of the ceramic nanorod material 530 to the total dielectric thin film is in the range of 20-80 weight percent. The binder material 520 makes up the balance of the composition. The combined ratios would be in the following ranges: 0.1-10.0 wt % graphene cores: 20-80 wt % ceramic nanorod material: 17-79 wt % binder material. An example composition of materials is: 2.5% graphene platelets, 78% ceramic material, 19.5% binder material. Once the desired composition of dielectric thin film 510 is determined, the desired thickness 550 for the required device and application specifications is determined. The dielectric thin film 510 has a desired layer thickness 550 of 1-500 um.

In one embodiment, the binder material 520 is a polymeric binder with known application in thin film application. For example, binder material 520 may be poly(vinyl pyrrolidone) (PVP), polyvinylodine fluoride (PVDF), copolymers of PVP, or copolymers of PVDF, such as PVDF-TFE (trifluoroethylene). For example, a 19.5% composition of PVDF may be used as binder material 520.

In one embodiment, the ceramic nanorod material 530 is made of a highly dielectric ceramic nanorod shell and graphene core 540. An example material is described above with regard to FIG. 4.

In one embodiment, the current collector 560 is an aluminum current collector. Current collector 560 is made from capacitor-grade aluminum foil having at least 99.99% purity. Commercially available “Cathode Foil” that is chloride etched 10% is well suited to the application. The etched surface of the current collector 560 provides the binding surface 570 for a dielectric thin film 510. Foil thickness may be selected from the range 17 um to 35 um, with 25 um being a preferred thickness.

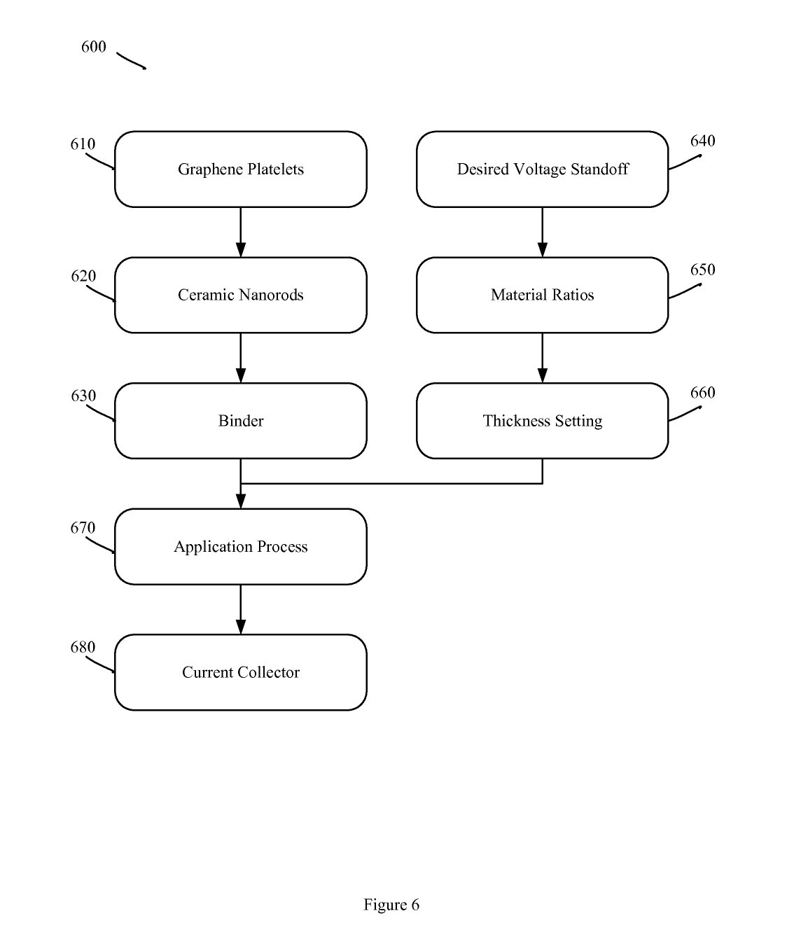

FIG. 6 shows a block diagram of a method 600 of making a highly dielectric electrode in accordance with an embodiment of the present invention. In step 610, high aspect ratio graphene platelets are selected for the electrode. For example, the powdered graphene platelets with the desired aspect ratio may be selected as described above with regard to FIGS. 2-5. In step 620, ceramic nanorods or nanorods with a high aspect ratio and high dielectric constant are selected for the electrode. For example, a ferroelectric ceramic nanomaterial powder with the desired aspect ratio may be selected as described above with regard to FIGS. 2-5. In one embodiment, a ceramic nanorod material with a graphene core is selected, combining step 610 and step 620, as described above with regard to FIGS. 4-5. In step 630, a binder material appropriate to thin film applications is selected for the electrode. For example, a polymeric binder with the desired application, curing, and mechanical properties may be selected as described above with regard to FIGS. 2-3 and 5.

In step 640, electrode specifications, including desired voltage standoff, are selected for the electrode. For example, desired voltage standoff, capacitance, and dielectric constant may be selected as appropriate to the device or application into which the electrode will be integrated. In step 650, material ratios are determined to achieve the desired voltage standoff and other electrode specifications based upon the materials selected in steps 610, 620, 630. For example, material ratios for the graphene platelets, ceramic materials, and binder may be determined based upon analysis or material testing to select desired values from the ranges described above with regard to FIGS. 2-3 and 5. In step 660, a thickness setting for the graphene dielectric thin film to be applied to the electrode is selected. For example, based upon the specifications, materials, and ratios, the desired thickness may be determined based upon analysis or material testing. In some embodiments, the graphene dielectric thin film may be applied in multiple layers and a plurality of layer thickness values will need to be determined as described above regarding FIG. 3.

In step 670, the selected materials, ratios, and thickness settings are input into an application process that will coat a target substrate with a precisely controlled graphene dielectric thin film. For example, a slurry of graphene platelets, ceramic material, binder, and solvent may be prepared in the selected ratios and placed in a thin film coating apparatus. In step 680, a graphene dielectric thin film with desired component ratios and thickness is applied to a current collector. For example, a thin film coating apparatus coats an aluminum substrate with a slurry of graphene platelets, ceramic material, binder and solvent in the desired thickness such that, when the film is dried or cured, the resulting graphene dielectric thin film has the desired voltage standoff and other specifications for the electrode.

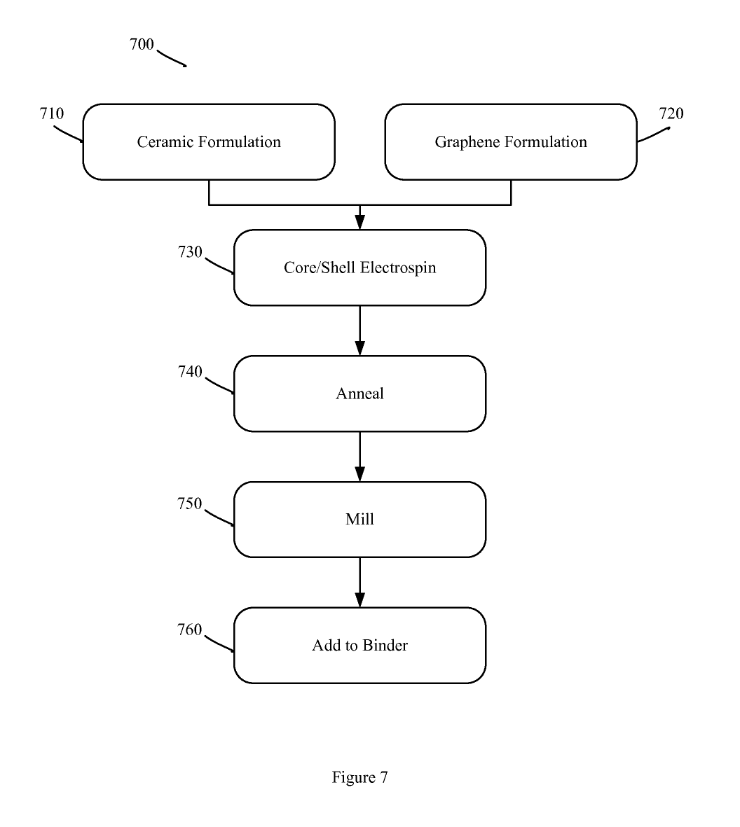

FIG. 7 shows a block diagram of a method 700 of making a ceramic nanorod material, such as ceramic nanorod material 400 in FIG. 4, for use in a highly dielectric electrode in accordance with an embodiment of the present invention. Electrospinning is used extensively as a versatile method for preparing uniaxially aligned nanorods made from organic polymers or ceramics. Method 700 uses a well-documented process and apparatus for shell-core electrospinning that employs inner and outer needles attached to separate pumps to simultaneously feed the shell and core materials in a uniaxial stream to create long shell-core nanofibers on a target collector.

In step 710, a ceramic formulation is prepared to create the ceramic shell material in the resulting ceramic nanorod material. For example, to form stoichiometric BaTiO3 a synthesis of barium acetate and titanium isopropoxide is first grown in a Sol-Gel process. This process is well-documented and includes other materials such as acetic acid and poly(vinyl pyrrolidone) PVP. After dissolution of all compounds in acetic acid and mixing/stirring for some time, the precursor is mixed with a solution of PVP and inserted into a first syringe. In alternate embodiments, the ceramic formulation is prepared to create a ceramic shell material out of another ferroelectric ceramic material, such as: BaTiO3 (barium titanate), Pb(Zr, Ti)O3 (lead zirconate titanate) also called PZT, CaCu3Ti4O12 (CCTO), Calcium barium zirconate titanate (Ba0.95Ca0.05Zr0.15Ti0.85O3, BCZT), etc. that yields hollow nanorod fibers with a high aspect ratio and high dielectric constant.

In step 720, a graphene formulation is prepared to create the graphene core in the resulting ceramic nanorod material. For example, a graphene platelet powder with the desired aspect ratio is added to a mineral oil formulation to achieve the desired core density (and resulting ceramic to graphene ratio). A second syringe is filled with the mineral oil formulation with additive graphene nanoplatelets of the desired size.

In step 730, the ceramic formulation and graphene formulation are put through a core/shell electrospinning process to generate long strands of ceramic nanorod fibers with a ceramic shell material and graphene core. For example, both the syringe with the ceramic formulation and the syringe with the graphene formulation are interfaced into a mixer barrel with the graphene formulation syringe needle extending through the ceramic formulation syringe needle. The graphene formulation syringe needle dispenses the graphene formulation in a stream that is coaxial and inside the stream of the ceramic formulation coming through the outer syringe needle. The solutions inside the two syringes are fed by the syringe pumps at fixed feeding rates. The ejector needle tip, final output of the combined formulation, is aluminum and connected to a 15 kv positive high voltage source. The collection plate at a certain distance (typically 6 to 10 centimeters) away, is connected to the low voltage negative side of the power supply which is grounded. Aluminum foil covers the negative collector, which provides the placement for the deposited material. As each material is pressed through their particular syringe by separate pumps it is extruded from the orifice of the outer needle to form a small droplet in the presence of an electric field. The droplets of the precursor ceramic material will change from a spherical to conical shape. When the electric field is sufficiently strong, charges built up on the surface of the droplet will overcome the surface tension to induce the formation of a liquid jet that is subsequently accelerated toward the negative field aluminum material collector. As the solvent is evaporating, this liquid jet is stretched to many times its original length to produce continuous, ultrathin nanorods. With continuous feeding, through the use of syringe pumps, long strands of ultrathin fibers can be obtained within a relatively short period of time. The electrospun ceramic nanorod fibers are then collected. They are heated to 120 degrees C. to evaporate any solvent, while leaving the graphene intact within the fibers, and vacuum dried at 80 degrees C. for one hour to prepare them for further processing. In some embodiments, a wash may be used to remove unwanted materials or otherwise modify the structure of the nanorods, such as employing organic solvents like heptanes.

In step 740, the ceramic nanorod fibers with graphene cores are annealed to create the desired phase change to a tetragonal ferroelectric structure. For example, the vacuum dried ceramic nanorod fibers are still in their cubic phase format. An annealing process can create the phase change into the desired tetragonal ferroelectric structure. The ceramic nanorod fibers with graphene cores are annealed at 450-750 degrees C. for 1-12 hours. After an hour the PVP is decomposed and the desired polycrystalline nanorod with reduced diameter results.

In step 750, the long strand ceramic nanorod fibers with graphene cores are milled to achieve the dielectric ceramic nanorod materials with the desired aspect ratio. For example, the long strand ceramic nanorod fibers may be ball milled into a fine ceramic powder with a mean aspect ratio (length to width) greater than 1000:1.

In step 760, the resulting ceramic nanorod material with graphene cores is mixed with a binder for thin film coating on a substrate. For example, the ceramic nanorod material with graphene cores may provide high aspect ratio, high dielectric constant ceramic material and high aspect ratio graphene platelets when added to a binder for a highly dielectric thin film coated on an aluminum current collector at a desired thickness to form a highly dielectric electrode with a desired voltage standoff.

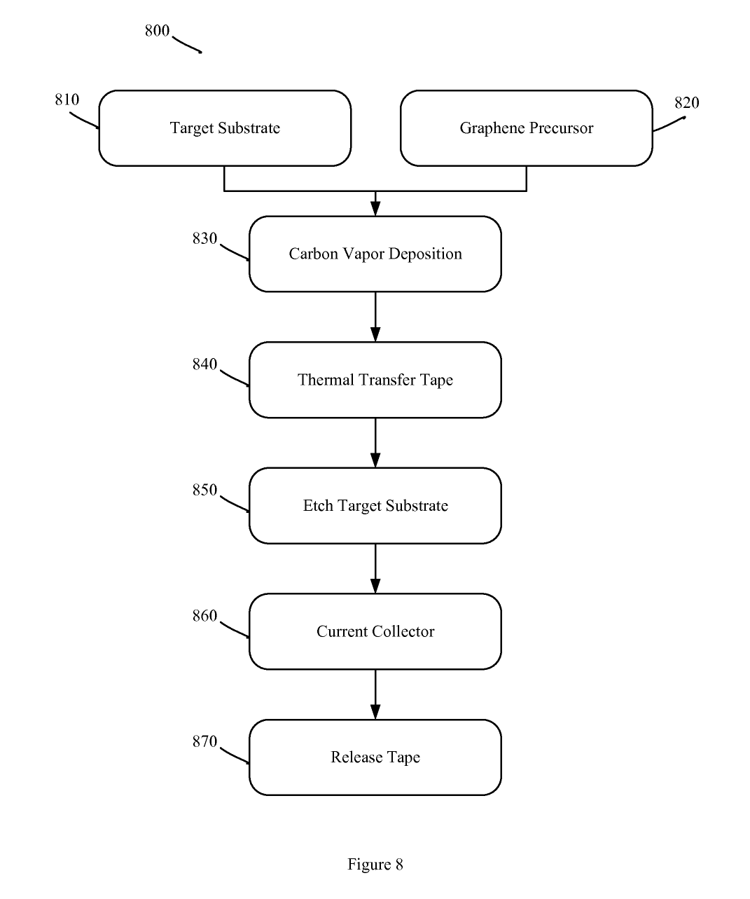

FIG. 8 shows a block diagram of a method 800 of making and transferring a graphene sheet thin film for use in a highly dielectric electrode, such as electrode 300 in FIG. 3, in accordance with an embodiment of the present invention. More specifically, the method 800 relates to creating graphene sheet thin films using chemical vapor deposition (CVD) and transferring the resulting graphene sheet thin films to other surfaces, such as a current collector, graphene sheet stack, or layered graphene dielectric thin film. The CVD graphene can be a single layer or multilayer and designed to be parallel to the target substrate and maintain that orientation when transferred to another surface, such as a current collector. The layered graphene, which acts as a dielectric in the direction perpendicular to the plane of the layer due to its low conductivity serves to determine the voltage standoff is function of the number of layers as well as the interface between the layered graphene and conductive substrate. In graphene electrolytic capacitor applications, electric double layer capacitance is also formed on the graphene/electrolyte interface. This configuration bridges the gap between conventional electrolytic capacitors and electric double layer capacitors (EDLCs). It combines the advantages of both; high working voltage, an attribute of traditional electrolytic capacitors, and high capacitance, which is characteristic of electric double layer capacitors.

In step 810, a target substrate is selected. For example, single layer or multilayers of graphene sheet(s) are grown on Cu or Ni substrates (respectively). In step 820, graphene precursor gases are selected for use in CVD to grow graphene on the selected target substrate. For example, decomposition of the precursor gases such as CH4, C2H4, etc. under Ar/H2 environment results in the formation of graphene on a target substrate. In step 830, a controlled CVD process grows a desired thickness of graphene on the target substrate. For example, a Ni substrate and precursor gases in an Ar/H2 environment may grow a graphene sheet of the desired thickness based upon the timing, precursor gases used, and environmental controls. The grown graphene sheet(s) may now be transferred to another surface, such as a current collector.

In step 840, thermal transfer tape is attached to the graphene sheet on the surface opposite the interface with the target substrate. For example, force may be applied to attach a thermal transfer tape to the graphene sheet. In step 850, the target substrate is etched from the graphene sheet and thermal transfer tape. For example, the target substrate, graphene sheet, and thermal transfer tape may be immersed in a bath of chemical etchant appropriate to target substrate and dissolve the target substrate material from the graphene sheet. The graphene sheet and thermal transfer tape may be thoroughly washed in distilled and deionized water to remove unwanted etchant and dissolved substrate material. In step 860, the graphene sheet with the thermal transfer tape still attached is applied to the current collector. For example, force may be applied to attach the surface of the graphene sheet opposite the interface with the thermal transfer tape (the same surface that was once attached to the target substrate) to an aluminum current collector. The same process may be used to apply the graphene sheet to another graphene sheet or another thin film layer. In step 870, the thermal transfer tape is released from the graphene sheet. For example, a heat treatment appropriate to the selected thermal transfer tape will cause the tape to release, leaving only the graphene sheet attached to the current collector or other new surface.

1. An electrode comprising:
a current collector with a surface; and
at least one thin film dielectric layer applied to the current collector and comprising a plurality of high aspect ratio graphene platelets in a known ratio to at least a film binder material and a desired layer thickness to produce a desired voltage standoff for the electrode.

2. The electrode of claim 1, wherein the electrode is an anode of an electrolytic capacitor.

3. The electrode of claim 1, wherein the at least one thin film dielectric layer is a plurality of thin film dielectric layers with an aggregate desired thickness to produce the desired voltage standoff for the electrode.

4. The electrode of claim 1, wherein the plurality of high aspect ratio graphene platelets have a mean aspect ratio of greater than 500:1.

5. The electrode of claim 1, wherein the desired voltage standoff for the electrode is in the range of 10-100 volts.

6. The electrode of claim 1, wherein the ratio of the plurality of high aspect ratio graphene platelets to the film binder material is in the range of 0.1-10.0 weight percent.

7. The electrode of claim 1, wherein the at least one thin film dielectric layer comprises a plurality of materials and the plurality of high aspect ratio graphene platelets is less than 10 weight percent of the at least one thin film dielectric layer.

8. The electrode of claim 1, further comprising a graphene sheet thin film dielectric layer grown on a second substrate using chemical vapor deposition and transferred to the current collector.

9. The electrode of claim 1, wherein the at least one thin film further comprises a ceramic material with a high aspect ratio and a high dielectric constant in a known ratio to the plurality of high aspect ratio graphene platelets and the film binder material.

10. The electrode of claim 9, wherein the known ratio among the plurality of high aspect ratio graphene platelets, the high aspect ratio ceramic material, and the film binder material is substantially 0.1-10.0 wt % graphene platelets: 20-80 wt % ceramic material: 17-79 wt % binder material.

11. The electrode of claim 9, wherein the high aspect ratio ceramic material comprises ferroelectric ceramic nanorods with a mean aspect ratio of greater than 1,000 and a dielectric constant of greater than 100.

12. The electrode of claim 9, wherein the high aspect ratio ceramic material comprises tetragonal BaTiO₃ fibers.

13. The electrode of claim 9, wherein the high aspect ratio ceramic material comprises a plurality of ceramic nanorod shells and at least a portion of the plurality of high aspect ratio graphene platelets form cores within the plurality of ceramic nanorod shells.

14. The electrode of claim 9, wherein the plurality of ceramic nanorod shells and the cores formed by the plurality of high aspect ratio graphene platelets are made by a core-shell electrospinning process.

15. The electrode of claim 1, wherein the film binder material is a polymeric material selected from the group of: poly(vinyl pyrrolidone) (PVP), polyvinylodine fluoride (PVDF), copolymers of PVP, and copolymers of PVDF.

16. A material comprising:
a ferroelectric ceramic nanorod shell defining an interior space; and
a graphene core disposed within the interior space.

17. The material of claim 16, wherein a plurality of the ferroelectric ceramic nanorod shells with graphene cores is disposed in a thin film comprising a polymeric binder material.

18. The material of claim 17, wherein the thin film comprising the polymeric binder material with the plurality of the ferroelectric ceramic nanorod shells with graphene cores disposed therein is applied to a current collector to form an anode for an electrolytic capacitor.

19. The material of claim 16, wherein the ferroelectric ceramic nanorod shell with the graphene core disposed therein is made by a core-shell electrospinning process.

20. A method comprising:
placing a ceramic formulation in a first pump connected to an outer needle;
placing a graphene formulation in a second pump connected to an inner needle; and
electrospinning nanofibers with a ceramic nanorod shell and a graphene core.

21. The method of claim 20, further comprising annealing the nanofibers to produce a tetragonal ferroelectric structure in the ceramic nanorod shell.

22. The method of claim 20, further comprising milling the nanofibers to produce a plurality of high aspect ratio ceramic nanorods with a graphene core and having a desired mean aspect ratio of greater than 1,000.

23. The method of claim 22, further comprising mixing the plurality if high aspect ratio ceramic nanorods with a graphene core with a polymeric binder material and applying it to a current collector in a thin film of a desired thickness to create an electrode with a desired voltage standoff.

24. A method comprising:
placing a first substrate having a target surface in an environment for a chemical vapor deposition process;
growing a substantially uniform layer of graphene on the target surface of the first substrate to form a graphene sheet thin film dielectric using chemical vapor deposition; and
transferring the graphene sheet thin film dielectric to a second substrate that is a current collector for an electrode.

25. The method of claim 24, wherein the graphene sheet thin film dielectric has a desired layer thickness to produce a desired voltage standoff for the electrode.

26. The method of claim 24, wherein a plurality of first substrates are used to grow a plurality of graphene sheet thin film dielectrics and the step of transferring the graphene sheet thin film dielectric to a second substrate further comprises:
transferring a first graphene sheet thin film dielectric of the plurality of graphene sheet thin film dielectrics to a surface of the second substrate; and
transferring each additional graphene sheet thin film dielectric of the plurality of graphene sheet thin film dielectrics to a surface of an adjacent graphene sheet thin film dielectric such that the plurality of thin film dielectrics form a stack having a desired thickness to produce a desired voltage standoff for the electrode.

27. The method of claim 24, further comprising adding an additional thin film dielectric layer to the electrode, wherein the additional thin film dielectric layer comprises a plurality of high aspect ratio graphene platelets in a known ratio to at least a film binder material and a desired layer thickness to produce a desired voltage standoff for the electrode.

28. The method of claim 24, wherein the step of transferring the thin film dielectric to the second substrate comprises:
applying a thermal transfer tape to the thin film dielectric while the thin film dielectric is attached to the first substrate;
removing the first substrate by etching;
applying the thin film dielectric to the second substrate while the thin film dielectric is attached to the thermal transfer tape; and
releasing the thermal transfer tape by applying heat.
